(19) United States
(12) Patent Application Publication
(10) Pub. No.: US 2001/0038391 A1
(43) Pub. Date: Nov. 8, 2001

(54) INFORMATION DISPLAY APPARATUS

(76) Inventor: HIDEO FUKUCHI, SUWA-SHI (JP)

Correspondence Address: OLIFF & BERRIDGE, P O BOX 19928, ALEXANDRIA, VA, 22320

(21) Appl. No.: 09/111,803

(22) Filed: Jul. 8, 1998

(30) Foreign Application Priority Data
Jan. 28, 1997 (JP) 9-13832
Jan. 28, 1997 (JP) 9-13833

(51) Int. Cl. G09G 5/34

(52) U.S. Cl. 345/684

(57) ABSTRACT

An information display apparatus is able to easily read a large amount of information even on a compact-sized display unit by improving a display mode in the display unit. In displaying characters on a liquid crystal display panel used for an information display apparatus, characters, such as “w”, “i”, and “n”, are given different widths by amounts such as five dots, one dot, and four dots, respectively. Even with the above amount of dots, the characters are sufficiently legible. Accordingly, characters are displayed with only minimal widths required for identifying them, and furthermore, only a limited space is interposed within the characters. Further, in displaying English words, a word is not broken across two lines to begin a new line. A fixed display method is used when an amount of information to be displayed is not greater than the number of lines in one frame. On the other hand, when an amount of information to be displayed exceeds one frame, a scrolling display is automatically repeated three times, and a user is informed that the amount of information exceeds one frame.

### BACKGROUND OF THE INVENTION

1. Field of Invention

The present invention relates to an information display apparatus, such as individually selective calling receivers equipped with a message display function. More particularly, the invention relates to a technique for effectively displaying a large volume of information on a limited size of display unit for use in a compact-sized information display apparatus.

2. Description of Related Art

In the field of information display apparatuses (compact-sized communication apparatuses), such as individually selective calling receivers, which are referred to as “beepers”, not only is there a display function of a caller's telephone numbers and an informing function by using, for example a bell, but additional functions, such as the display of various messages, are also becoming available. Characters of a font for displaying such messages are conventionally the same width regardless of the types of characters.

It is convenient if long messages can be displayed even in the above type of compact-sized information display apparatus. To achieve this function, the display apparatus should be enlarged, which however causes an impairment of the portability of the apparatus. Accordingly, in a compact-sized information display apparatus, such as an individually selective calling receiver, the display mode may be improved to display a large volume of information on a compact-sized display unit. Sufficient improvement has not been made, however, in the known information display apparatuses from the above point of view.

For example, the known information display apparatuses present the following problems. In displaying messages alphabetically, characters, such as “w” and “i”, have different required widths (the number of dots in the horizontal direction). However, such alphabetic characters are conventionally displayed in the same width, generating wasted space in a line and reducing the number of characters which are displayable in the same line.

In a manner similar to long messages displayable in the compact-sized information display apparatuses, a plurality of lines can be displayed in some display apparatuses. In displaying English words in such apparatuses, beginning a new line is frequently required by breaking a word across two lines, which makes it hard to read such messages.

The following method may be considered in a manner similar to long messages displayable in the compact-sized information display apparatuses. When a long message is received, it is determined that one page is the amount of message which is displayable in one frame of a display unit and a plurality of pages of the message are stored as information. Then, only one page of the message is displayed, and the amount of remaining pages is also displayed. With this arrangement, the user is able to recognize that the currently displayed message is to be continued. If the display is updated in each frame as if the pages are sequentially turned, the user is able to read through the whole received information. Accordingly, the whole information can be displayed even if the received information exceeds the amount of information which is displayable in one frame. This eliminates the limitation of the amount of information which can be received at one time in information display apparatuses provided with only a small display unit. However, the above display mode presents the following new problem. Although a large amount of information can be displayed, the display content of one page is completely different from that of another page, thereby making it hard to read the contents of the display. Moreover, an operation, such as the pressing of a button, is required every time the frames are changed from one page to another after reading the currently displayed page. Therefore, if a large amount of information is received, it is troublesome and time-consuming to read through it.

### SUMMARY OF THE INVENTION

In view of the above-described problems, the present invention provides an information display apparatus in which a large amount of information can be easily read even on a compact-sized display unit by improving the display mode for use in the display unit.

In order to implement an information display apparatus that is able to easily read a large amount of information even on a compact-sized display unit, according to one aspect of the present invention, a font used for displaying characters increases the number of characters displayable within each line. More specifically, according to this aspect of the present invention, there is provided an information display apparatus including a display unit for displaying information, display control means for controlling a display operation of the display unit, and an operating unit for designating a display operation of the display unit. The display control means has a font whose width varies according to the type of character used for horizontally displaying a group of a plurality of lines of characters on the display unit. The display control means also controls the display operation of the display unit so that the spacing between the characters is constant.

More specifically, the sizes (widths) of characters, such as “w”, “i”, and “n”, are horizontally different by amounts equal to five dots, one dot, and four dots, respectively, for example. Accordingly, in the present invention, characters are displayed with only minimal widths required for identifying them, and furthermore, only a limited space is interposed between the characters. Hence, the greatest possible number of characters within each line are displayed, and they are easy to identify. A long message can thus be displayed even on a small display unit.

In the present invention, in displaying words as a group of characters, the display control means may preferably be configured in the following manner. The display control means may determine whether to start a new line by determining whether it would be necessary to break a word across two lines. When it is not necessary to break a word, a new line is started after the word. When it is necessary to break a word, a new line is started before the start of the word. The number of returns is inevitably increased if the display unit is smaller. However, since it is not necessary to break a word across two lines in performing a line feed, messages are easy to read, which would otherwise cause an impairment of reading messages displayed in English.

According to another aspect of the present invention, scroll display is employed to increase an amount of displayable information. More specifically, according to this aspect of the present invention, there is provided an information display apparatus including a display unit for displaying information, display control means for controlling a display operation of the display unit, and an operating unit for designating a display operation of the display unit. The display control means causes the display unit to form a fixed display in a case where an amount of information to be displayed on the display unit is not greater than an amount displayable in one frame. Conversely, the display control means causes the display unit to automatically form a scrolling display a plurality of times continuously in a case where an amount of information to be displayed exceeds an amount displayable in one frame.

For example, the display control means may cause the display unit to display information formed of a group of characters vertically or horizontally over a plurality of lines. The display control means may cause the display unit to form a fixed display in a case where an amount of information to be displayed is not greater than a number of lines displayable in one frame. In contrast, the display control means may cause the display unit to form a scrolling display a plurality of times continuously in a case where an amount of information to be displayed exceeds a number of lines displayable in one frame. In this case, vertically displayed information is scrolled horizontally, while horizontally displayed information is scrolled vertically.

Hitherto, if information to be displayed exceeds a number of lines displayable in one frame, the whole display content is switched from one page to another by pressing the button switch as if pages are sequentially turned. Unlike this conventional mode, according to the present invention, a scrolling display is automatically formed. Thus, even when a large amount of information is displayed on a small display unit, the contents of display are easy to read, and a manual operation is not required, which would otherwise be troublesome and time-consuming.

In the present invention, the display control means may preferably be configured to change the scroll speed determined at the start of the scrolling display in accordance with an operation performed on the operating unit. With this arrangement, since the scroll speed may be adjustable to a suitable speed, information can be reliably read even in the scrolling display.

In one form of adjusting the scroll speed, according to the present invention, the display control means may preferably be configured to change the scroll speed in accordance with an operation externally performed on the operating unit, which provides an instruction to change a predetermined scroll speed determined at the start of the scrolling display. With this arrangement, the scroll speed is adjustable to be a suitable speed while observing the actual scrolling display, thereby making it possible to easily read information even in the scrolling display.

In another form of adjusting the scroll speed, according to the present invention, the display control means may preferably be configured to preset via the operating unit the scroll speed determined at the start of the scrolling display. With this arrangement, the scroll speed is adjustable to be optimal in advance in accordance with the user's reading speed, thereby making it possible to easily read information even in the scrolling display.

In this case, the display control means may preferably cause the display unit to perform a demonstration display at a currently set scroll speed, which is determined at the start of the scrolling display via the operating unit.

The foregoing information display apparatus is suitably used as an information communication apparatus in which information received via a communication circuit is displayed on the display unit.

In this case, the information display apparatus may preferably have informing means for informing whether information received via the communication circuit exceeds a number of lines displayable in one frame of the display unit.

### BRIEF DESCRIPTION OF THE DRAWINGS

FIGS. 1(A), 1(B), and 1(C) illustrate switching operations of the display modes of an information display apparatus formed by application of the present invention, and FIG. 1(D) is a view partially enlarged from the above display mode illustrating a font used for horizontally displaying alphabetic characters;

FIG. 2 is a block diagram illustrating the functions of the essential portions of an information display apparatus formed by application of the present invention;

FIG. 3 illustrates the overall function of an information display apparatus formed by application of the present invention;

FIG. 4 is a flow chart illustrating an example of the basic operation immediately after a message is received performed by an information display apparatus which is formed by application of the present invention;

FIG. 5 is a flow chart illustrating another example of the basic operation immediately after a message is received performed by an information display apparatus which is formed by application of the present invention;

FIG. 6 is a flow chart illustrating still another example of the basic operation immediately after a message is received performed by an information display apparatus which is formed by application of the present invention;

FIG. 7 is a flow chart illustrating the reproducing operation of a received message performed by an information display apparatus which is formed by application of the present invention;

FIG. 8 is a flow chart illustrating the scroll speed setting operation performed by an information display apparatus which is formed by application of the present invention; and

FIG. 9(A) is a flow chart illustrating an example of the scroll speed changing operation performed by an information display apparatus formed by application of the present invention, and FIG. 9(B) is a flow chart illustrating another example of the scroll speed changing operation performed by an information display apparatus formed by application of the present invention.

### DETAILED DESCRIPTION OF PREFERRED EMBODIMENTS

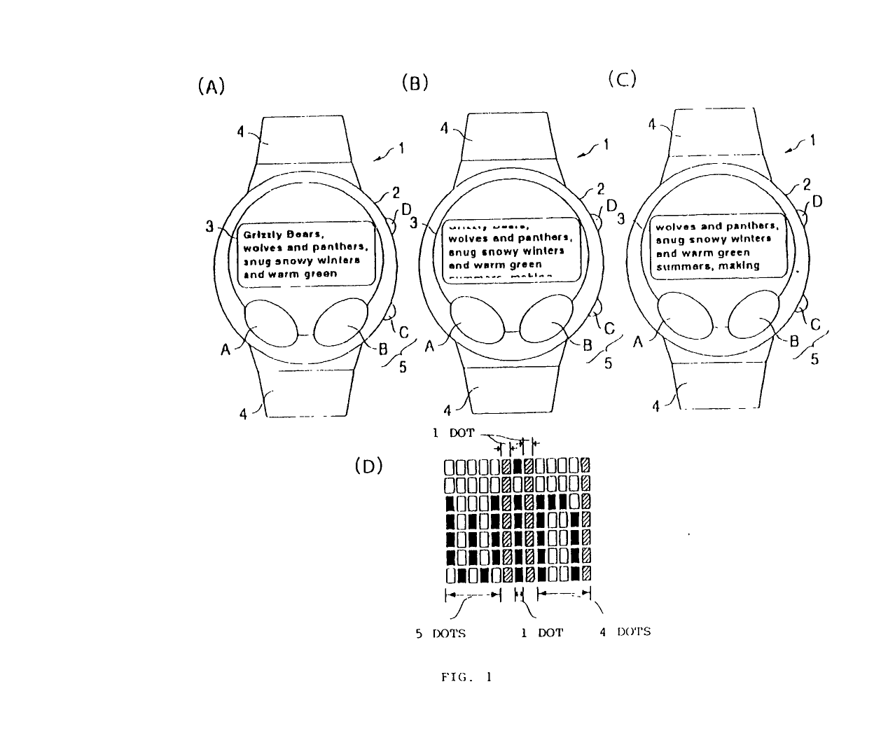

FIGS. 1(A) 1(B), and 1(C) illustrate the switching operation of display modes on a display unit for use in an information display apparatus formed by application of the present invention. FIG. 1(D) illustrates a font used for horizontally displaying alphabetic characters.

An information display apparatus 1 according to an embodiment of the present invention, which is usable as a wrist-fit-type individually selective calling receiver equipped with a message display function, is formed, as illustrated in FIGS. 1(A), 1(B), and 1(C), of an apparatus main unit 2 on which a rectangular liquid crystal display panel 3 (display section) is mounted, and a wrist band 4 used for attaching the main unit 2 to a wrist.

In this information display apparatus 1, a loop antenna or a slot antenna is integrated into the main unit 2 or the wrist band 4. The main unit 2 has a built-in circuit assembly (not shown), which includes a circuit board and a circuit driving battery. Mounted on the circuit board are various electronic parts, such as a high frequency analog IC and a signal processing digital IC, which form a receiving communication circuit.

Two button switches A and B are disposed on the obverse surface of the main unit 2, while two button switches C and D are provided on the peripheral portion of the main unit 2. The button switches A, B, C, and D form an operating section 5 of the information display apparatus 1, which is used for instructing the liquid crystal display section 3 to display the time and the received information, and also for designating the reproduction and the display of a given item of received information. These functions are described later.

The liquid crystal display panel 3 is the type which performs dot display. In this embodiment, four lines of characters can be displayed horizontally. Further, the liquid crystal display panel 3 is capable of displaying approximately 20 characters per line. In this embodiment, however, since a font is configured in such a manner that the size (width) of the characters is changeable according to the type of character to be displayed, the number of characters displayable per line varies according to the content to be displayed.

More specifically, as shown in FIG. 1(D), the spacing between adjacent characters, which is equal to one dot, is constant regardless of the type of character. However, the sizes (widths) of the characters, such as “w”, “i”, and “n”, are different by amounts equal to five dots, one dot, and four dots, respectively. Namely, a font is configured so that only a minimal number of dots is required for character display. Thus, although the vertical levels of the characters are conventionally the same, they are not always equal to each other in this embodiment. Yet, since the number of dots in the horizontal direction changes according to the type of character, the greatest possible number of characters can be contained within each line, and furthermore, the characters are easy to identify.

In this embodiment, in displaying messages in English on the liquid crystal display panel 3, a determination is made for each word of whether to start a new line by breaking the word. If it is not necessary to break a word across two lines, the word is displayed as it is. On the other hand, if the word should be broken across two lines, a new line is started before the word. Thus, in the message shown in FIG. 1 (C), although a line feed would conventionally be performed from the third line to the fourth line by breaking the word “summers”, a new line is already begun before the start of the word “summers” in the fourth line in this embodiment. Accordingly, the number of returns is inevitably increased if the liquid crystal display panel 3 is smaller. However, since it is not necessary to break a word across two lines in performing a line feed, messages are easy to read.

In this manner, the greatest possible number of characters are displayed within each line and each frame, and the characters are easy to read. Additionally, in this embodiment, if the information to be displayed on the liquid crystal display panel 3 exceeds an amount of information displayable in one frame, the liquid crystal display panel 3 is caused to automatically scroll the information (scroll display). In contrast, if the information to be displayed on the liquid crystal display panel 3 is not greater than an amount of information displayable in one frame, the liquid crystal display panel 3 is caused to fix the information without scrolling it (fixed display). Namely, in this embodiment, when an amount of information to be displayed is not more than four lines, a fixed display method is used in which the individual characters are displayed while keeping the same positions on the liquid crystal display panel 3. When an amount of information to be displayed exceeds four lines, scroll display is performed in the upward direction, as indicated in the display modes in chronological order shown in FIGS. 1(A), 1(B), and 1(C). Information (message) formed of a long group of characters exceeding four lines is referred to as a “long message”, while information (message) formed of a short group of characters not more than four lines is referred to as a “short message”.

Then, upon completing the display of the final page of the received information according to the scroll display method, the first page (top page) may again be displayed. Thereafter, scroll display may automatically be performed continuously three times.

In this manner, when the information to be displayed exceeds the number of lines displayable in one frame, scroll display may automatically be repeated. Thus, even if a large amount of information (long message) is displayed on a compact-sized liquid crystal display panel 3, the contents of the display are easy to read, and a manual operation is not required, which would otherwise be troublesome and time-consuming.

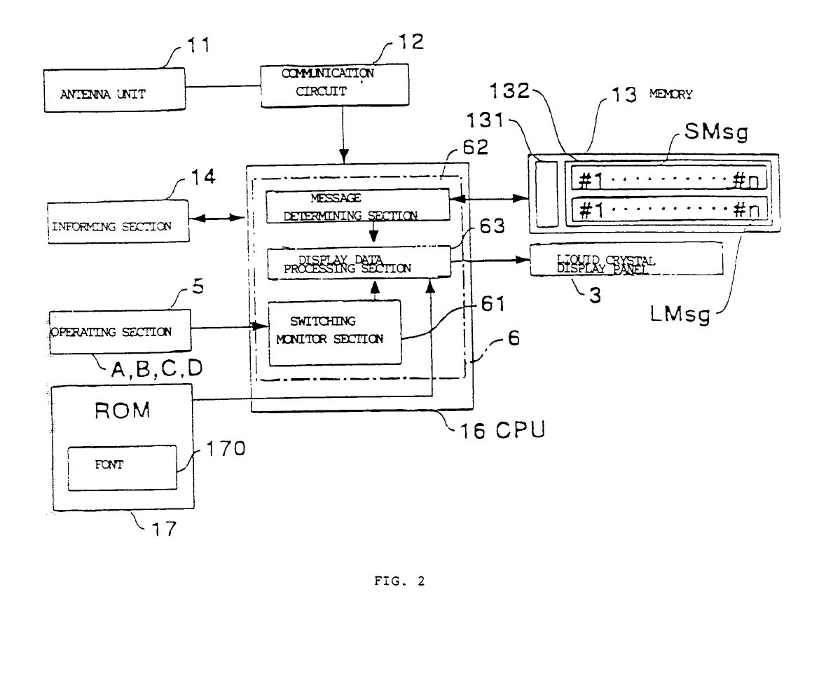

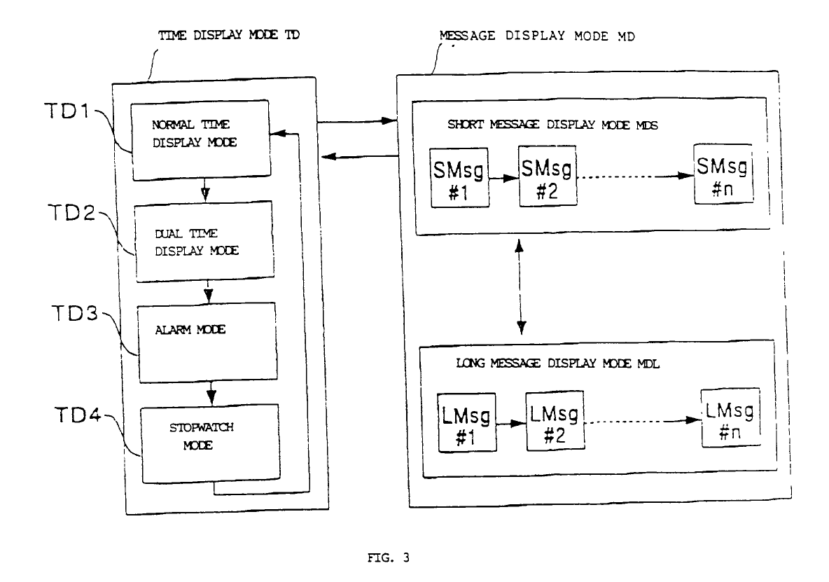

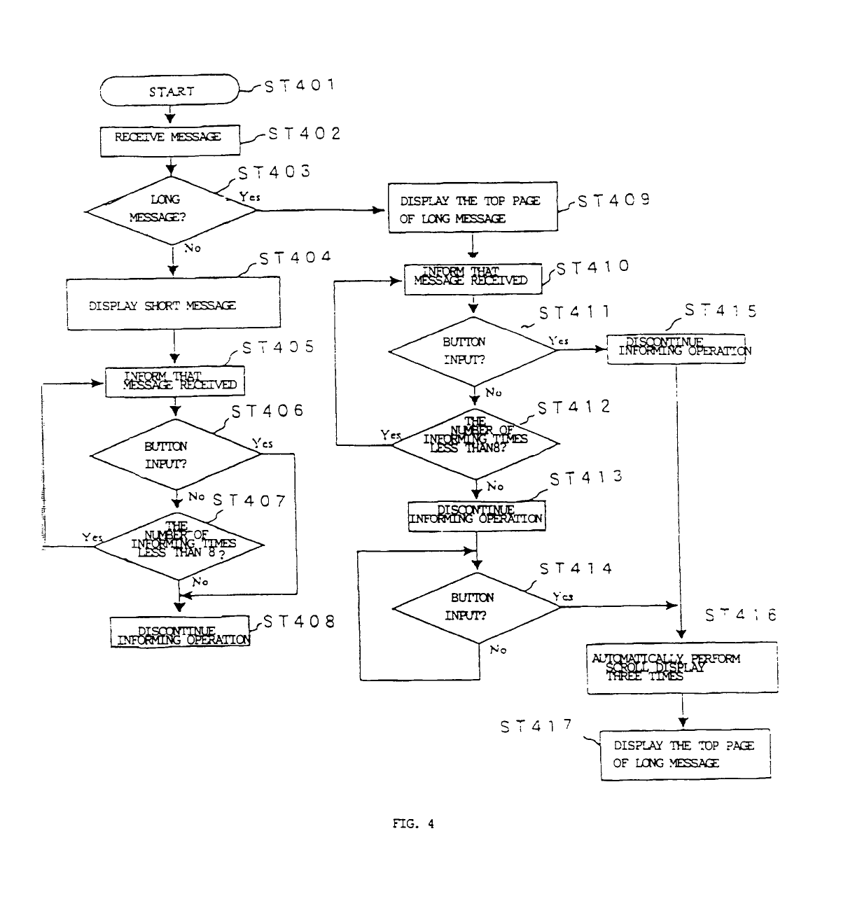

FIG. 2 is a block diagram illustrating the functions of the elements of an information display apparatus formed by the present invention.

To configure the above-described display mode, the information display apparatus 1 of this embodiment has, as indicated by the block diagram of FIG. 2, an antenna unit 11, a communication circuit 12, a memory 13, a liquid crystal display panel 3, an operating section 5, display control means 6, and an informing section 14. The communication circuit 12 receives messages via the antenna unit 11. The memory 13 stores the message received via the communication circuit 12 together with its sender and its received time. The liquid crystal display panel 3 displays the received information and time. The operating section 5, which is formed of button switches A, B, C, and D, is used for instructing from exterior of the liquid display panel 3 to display messages. The display control means 6 controls the display operation performed by the liquid crystal display panel 3. The informing section 14 informs the user by a buzzer or vibration that a message has been received. The display control means 6 is formed of the following elements. A switching monitor section 61 monitors the operation on the button switches A, B, C, and D. When the message is to be reproduced, the message determining section 62 determines, based on the monitoring results by the switching monitor section 61, whether the message read from the memory 13 is a short message or a long message. A display data processing section 63 processes data for performing scroll display depending on the type of message based on the results determined by the message determining section 62 and outputs the processed data to the liquid crystal display panel 3. Stored in a ROM 17 is a font 170 whose number of dots in the horizontal direction is changed according to the type of character.

The display data processing section 63 also executes the following data processing. When words are to be displayed as a group of characters, the display data processing section 63 makes a determination of whether to begin a new line by breaking a word. If it is determined that it is not necessary to break the word across two lines, a new line is started after the word. On the other hand, if it is determined that the word should be broken across two lines, a new line is started before the word so that the word is not broken across two lines. The display control means 6 can be implemented by using a conventional CPU 16 or other processing device for controlling the overall information display apparatus 1 including display control. Any processing device could be used in place of CPU 16 as long as it is capable of implementing the desired functions. For example, the CPU 16 could be replaced by a programmed microprocessor or microcontroller, an ASIC or other integrated circuit, a digital signal processor, a hardwired electronic or logic circuit, or a programmable logic device such as a PLD, PLA, FPGA, PAL or the like.

The CPU 16 is operable based on a program stored in, for example, the ROM 17. ROM 17 could be replaced by other devices such as a PROM, an EPROM, or an EEPROM, for example.

Further, the message determining section 62 also determines whether the message currently received via the communication circuit 12 is a short message. The informing section 14 provides information based on the results determined by the message determining section 62 by changing the type of sound depending on the currently received message being a short message or a long message.

Stored in the memory 13 are a header 131 and messages 132 corresponding to the header 131. The messages 132 are stored in the memory 13 as short messages SMsg#1 through SMsg#n and as long messages LMsg#1 through LMsg#n.

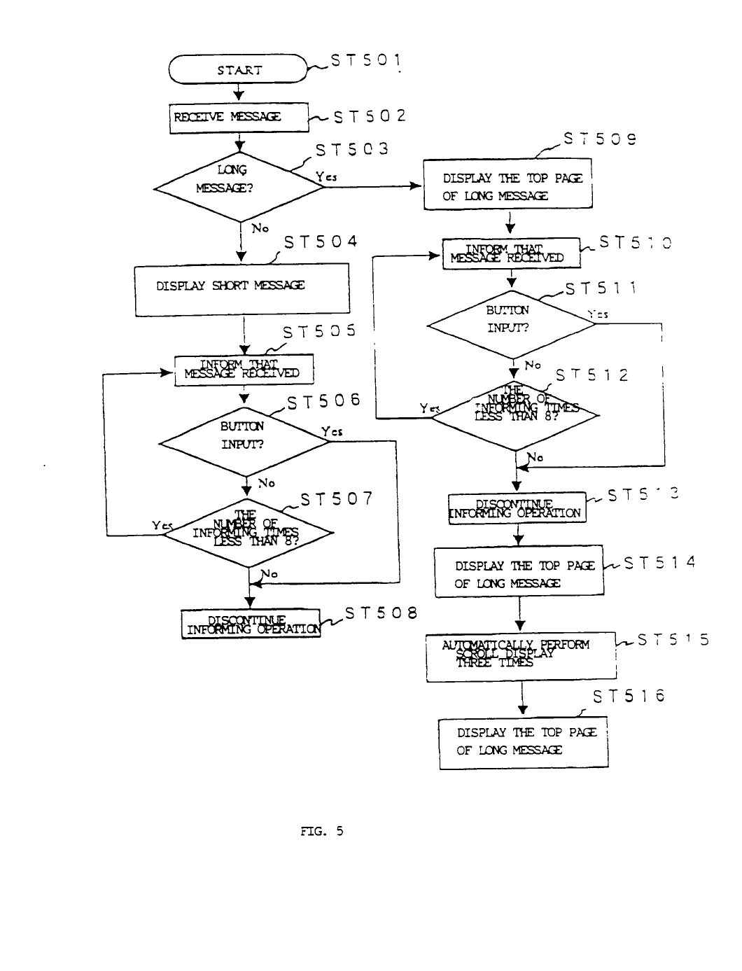

The basic operation of the information display apparatus 1 constructed as described above is, in general, as shown in FIG. 3. More specifically, the information display apparatus 1 is set in a time display mode TD while it is in the receiving standby position. Every time the button switch A is pressed, the time display mode TD is sequentially switched between a normal time display mode TD1, a dual time display mode TD2 in which an additional time is also displayed, an alarm mode TD3, and a stopwatch mode TD4, and it is finally returned to the normal time display mode TD1. When the button switch B is pressed while the information display apparatus is in the time display mode TD, or when a message is newly received while the information display apparatus 1 is in any mode, the mode is switched to a message display mode MD. Conversely, when the button switch A is pressed while the information display apparatus 1 is in the message display mode MD, or when none of the button switches has been pressed for, for example, two minutes, the information display apparatus 1 is returned to the time display mode TD. However, the functions of the button switches could be switched as desired.

In the message display mode MD, every time the button switch B is pressed, the messages are time-sequentially read from the latest message. According to the type of message (the length of the message), however, the message display mode MD is automatically switched to a short message display mode MDS in which fixed display is performed or a long message display mode MDL in which scroll display is performed (scroll display: see FIG. 1).

The above-described display modes are implemented by processing, which will be described with reference to FIGS. 4 through 6.

FIG. 4 is a flow chart illustrating an example of the basic operation after a message is received performed by an information display apparatus which is formed by application of the present invention. In this example, scroll display is performed on a received long message only after the button switch B is actuated after the message is received.

The operation starts in step ST401, as shown in FIG. 4. After a message is received in step ST402, it is determined in step ST403 as to whether the received message is a long message.

If it is found in step ST403 that the received message is a short message, the short message is displayed in step ST404, and then, information indicating that a message has been received is provided to the user in step ST405. Subsequently, while the presence or the absence of input from the button switch B and the number of informing times are being monitored in step ST406 and step ST407, the information continues to be provided up to a total number of eight times, although a different number of times could be used. During steps ST406 and ST407, if it is determined that there has been input from the button switch B (step ST406) or if it is determined that the information has been provided eight times (step ST407), the informing operation is discontinued in step ST408.

If it is judged in step ST403 that the received message is a long message, the top page of the long message is displayed in step ST409, and information indicating that the message has been received is provided in step ST410. While the presence or the absence of input from the button switch B and the number of informing times are being monitored in steps ST411 and ST412, the information continues to be provided to the user up to a total number of eight times.

During steps ST411 and ST412, if it is determined that there has been input from the button switch B (step ST411), the informing operation is discontinued in step ST415. Thereafter, scroll display of the long message is repeatedly performed three times in step ST416, and then, the display is returned to its original state in which the top page of the long message is displayed in step ST417.

If it is determined that the information has been provided to the user eight times in step ST412, the informing operation is also discontinued in step ST413. In this case, the information display apparatus 1 is in the standby position until there is any input from the button switch B in step ST414. If there has been input from the button switch B, scroll display of the long message is repeatedly performed three times in step ST416, and then, the display is returned to its original state in which the top page of the long message is displayed in step ST417.

FIG. 5 is a flow chart illustrating another example of the basic operation after a message is received performed by an information processing apparatus which is formed by the present invention. In this example, even if there is no input from the button switch B after the message is received, information indicating that the message has been received is provided to the user, and then, scroll display of the long message is performed.

The operation starts in step ST501, as illustrated in FIG. 5. After a message is received in step ST502, a determination is made in step ST503 of whether the received message is a long message.

If it is determined in step ST503 that the received message is a short message, the short message is displayed in step ST504, and information indicating that the message has been received is provided to the user in step ST505. Then, while the presence or the absence of input from the button switch B and the number of informing times are being monitored in steps ST506 and ST507, the information continues to be provided up to a total number of eight times. During steps ST506 and ST507, if it is judged that there has been input from the button switch B (step ST506), or if it is judged that information has been provided eight times (step ST507), the informing operation is discontinued in step ST508.

If it is determined in step ST503 that the received message is a long message, the top page of the long message is displayed in step ST509, and then, information indicating that the message has been received is provided to the user in step ST510. Subsequently, while the presence or the absence of input from the button switch B and the number of informing times are being monitored in steps ST511 and ST512, the information continues to be provided to the user up to a total number of eight times.

During steps ST511 and ST512, if it is judged that there has been input from the button switch B in step ST511, the informing operation is discontinued in step ST513. Thereafter, the top page of the long message is displayed in step ST514, and then, scroll display of the long message is repeatedly performed three times in step ST515. The display is then returned to its original state in which the top page of the long message is displayed in step ST516.

On the other hand, even if there is no input from the button B, the informing operation is also discontinued in step ST513 if it is determined that information has been provided to the user eight times in step ST512. The top page of the long message is then displayed in step ST514, and scroll display of the long message is repeatedly performed three times in step ST515. Subsequently, the display is returned to its original state in which the top page of the long message is displayed in step ST516.

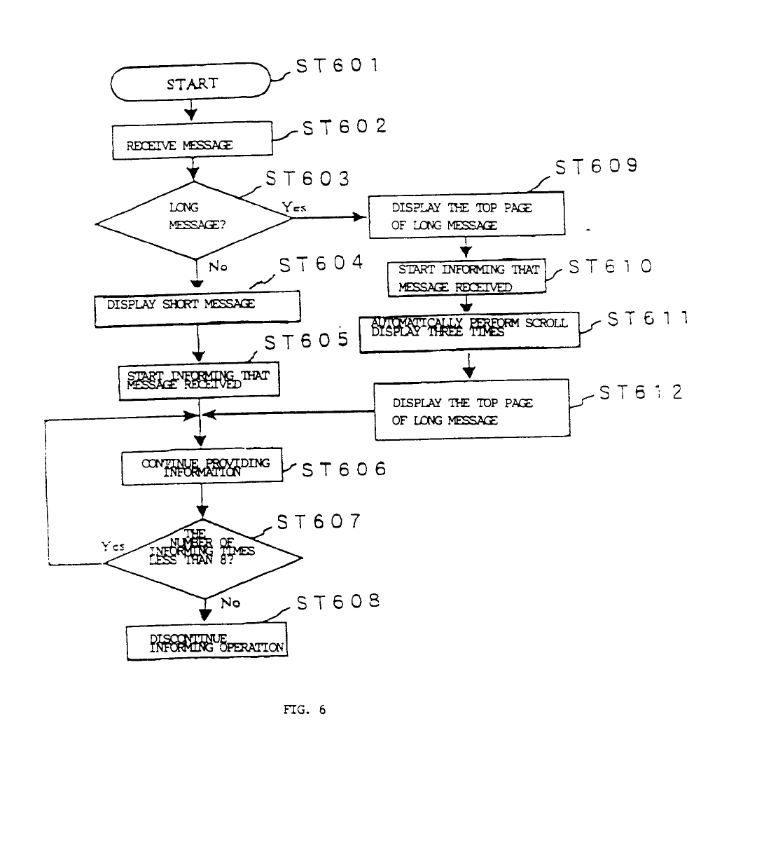

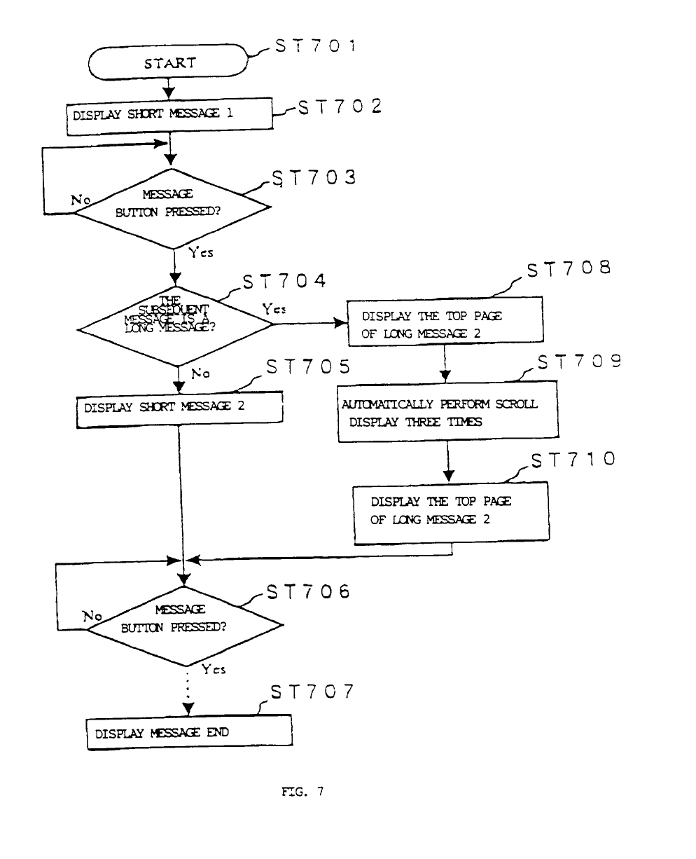

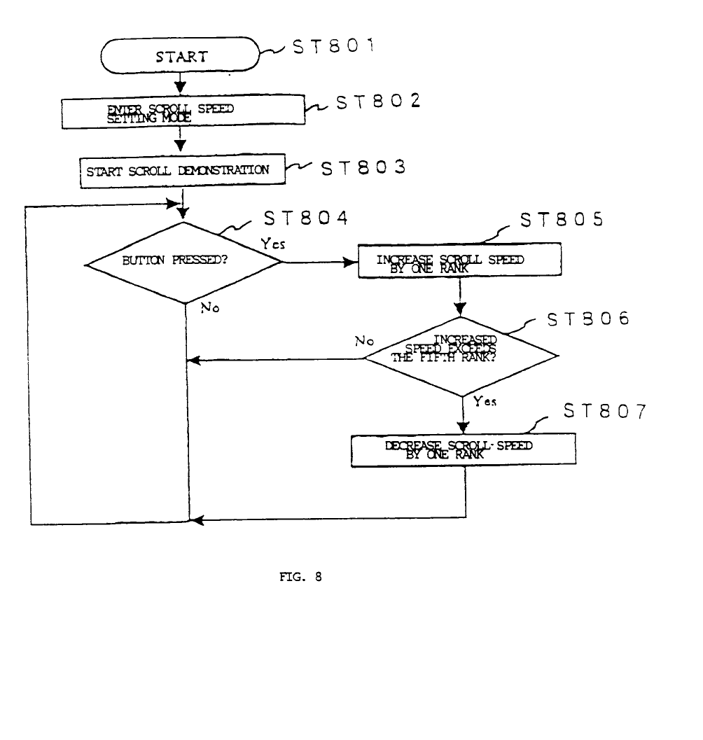

FIG. 6 is a flow chart illustrating still another example of the basic operation after a message is received performed by an information display apparatus which is formed by application of the present invention. In this example, scroll display is performed immediately after a message is received.

The operation starts in step ST601, as illustrated in FIG. 6. After a message is received in step ST602, a determination is made in step ST603 of whether the received message is a long message.

If it is found in step ST603 that the received message is a short message, the short message is displayed in step ST604, and information indicating that the message has been received starts to be provided to the user in step ST605. While the number of informing times is being monitored, the information continues to be provided up to a total number of eight times in steps ST606 and ST607. If it is judged that the information has been provided eight times in step ST607, the informing operation is discontinued in step ST608.

Conversely, if it is judged in step ST603 that the received message is a long message, the top page of the long message is displayed in step ST609, and information indicating that the long message has been received starts to be provided to the user in step ST610. Subsequently, after scroll display of the long message is repeatedly performed three times in step ST611, the display is returned to its original state in which the top page of the long message is displayed in step ST612. Thereafter, while the number of informing times is being monitored, the information continues to be provided up to a total number of eight times in steps ST606 and ST607. If it is determined that the information has been provided eight times in step ST607, the informing operation is discontinued in step ST608.

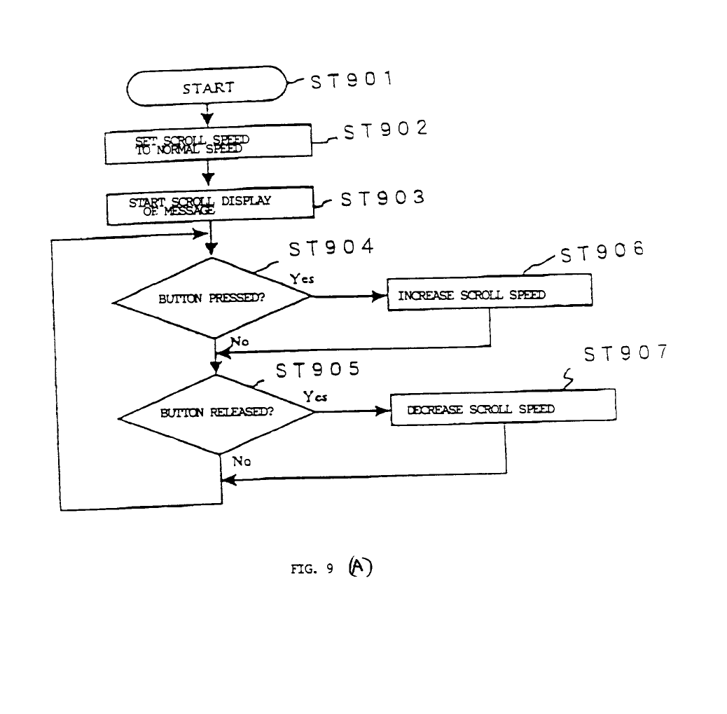

FIG. 7 is a flow chart illustrating the reproducing operation of received messages performed by an information display apparatus which is formed by application of the present invention. In this example, messages are sequentially displayed starting from the latest message, and scroll display is automatically performed on any long message.

After the information display apparatus enters the received message reproducing mode in step ST701, a short message 1 is first displayed in step ST702, as illustrated in FIG. 7. Then, the process is in the standby mode until the button switch B is pressed in step ST703. If it is judged in step ST703 that the button switch B has been pressed, a determination is made of whether the subsequent message is a long message in step ST704.

If it is judged in step ST704 that the subsequent message is not a long message, i.e., it is a short message, the subsequent short message 2 is displayed in step ST705. The process is then in the standby position until the button switch B is pressed in step ST706.

In contrast, if it is determined in step ST704 that the subsequent message is a long message, the top page of the long message 2 is displayed in step ST708. Then, after scroll display of the long message 2 is repeatedly performed three times in step ST709 and the top page is displayed in step ST710, the process is in the standby position until the button switch B is pressed in step ST706.

The foregoing operation is repeated to sequentially display n number of received messages. Upon completing the display of all the messages, information indicating that all the messages have been displayed (message end) is displayed in step ST707.

Scroll Speed Setting Mode

In this embodiment, the scroll speed used for performing scroll display of long messages can be set in advance by the following operation. The user operates the button switch B to set the information display apparatus in the setting mode and further operates the switch B in the same mode. Consequently, although the reading speed varies among individuals, the user is able to scroll the message at his/her reading speed.

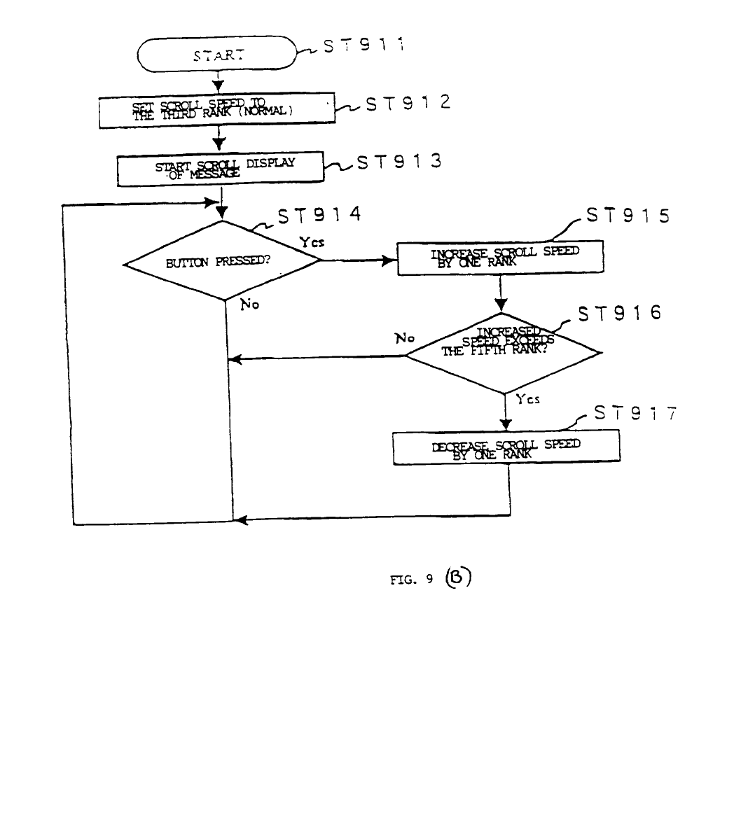

Such a display mode can be implemented by an operation, such as, the one illustrated in FIG. 8. FIG. 8 is a flow chart illustrating the scroll speed setting operation performed by an information display apparatus which is formed by application of the present invention.

A predetermined operation is performed in step ST801 (which may be operation of button switch B), as shown in FIG. 8, to enter the scroll speed setting mode in step ST802. In the scroll speed setting mode, the scroll speed is first set to the normal speed (which may be the third rank among five ranks), and scroll display is performed on a preset message sample as a demonstration display in step ST803.

While the demonstration display is being performed, it is monitored to determine whether or not the button switch B has been pressed in step ST804. If it is determined that the button switch B has been pressed, the scroll speed is raised by one rank in step ST805. It is then further determined whether the raised speed rank exceeds the fifth rank in step ST806. If it is found in step ST806 that the speed rank is not greater than the fifth rank, the increased rank speed is set as the scroll speed. Conversely, if it is determined in step ST806 that the speed rank exceeds the fifth rank, the speed is decreased by one rank in step ST807, and the decreased speed is set as the scroll speed to be used when the scroll display is started.

Scroll Speed Changing Operation

In this embodiment, if the preset scroll speed is not desirable, it is possible to change the scroll speed by operating the button switch B at any timing after scroll .display is started. Therefore, the scroll speed can be changed while the user is observing the actual scroll display. More specifically, if the displayed information is simple, the scroll speed can be increased to read it quickly. On the other hand, if the displayed information is complicated and important, the scroll speed may be decreased to peruse it. In this manner, the scroll speed is adjustable to be optimal for the particular content of information or the user's reading speed, thereby making it possible to easily read messages even in scroll display.

Such a display mode can be implemented by an operation, such as the one illustrated in FIGS. 9(A) or 9(B). FIG. 9(A) is a flow chart illustrating an example of the scroll speed changing operation performed by an information display apparatus which is formed by application of the present invention. FIG. 9(B) is a flow chart illustrating another example of the scroll speed changing operation performed by an information display apparatus which is formed by application of the present invention.

Scroll Speed Changing Operation

### EXAMPLE 1

Display of a long message is started, as shown in FIG. 9(A) in step ST901. The scroll speed is then set to the normal speed in step ST902 to start scroll display of the message in step ST903.

While scroll display is being performed at the normal speed, it is monitored to determine whether or not the button switch B has been pressed in step ST904. If it is found that the button switch B has been pressed, the scroll speed is increased in step ST906), and the increased scroll speed is maintained until the button switch B is released. Thereafter, if the button switch B is released, the scroll speed is returned to the normal speed in steps ST905 and ST907.

Scroll Speed Changing Operation

### EXAMPLE 2

Display of a long message is started in step ST911, as illustrated in FIG. 9(B). The scroll speed is then set to the normal speed (the third rank among five ranks) in step ST912 to start scroll display of the long message in step ST913.

While scroll display is being performed at the normal speed, it is monitored to determine whether or not the button switch B has been pressed. If it is determined that the button switch B has been pressed, the scroll speed is raised by one rank in steps ST914 and ST915, and a determination is further made of whether the increased speed rank exceeds the fifth rank in step ST916. If it is determined in step ST916 that the speed rank is not greater than the fifth rank, the increased speed is maintained to perform scroll display. If it is determined in step ST916 that the speed rank exceeds the fifth rank, the speed rank is reduced to the first rank in step ST917, and scroll display is performed at this rank.

In the foregoing embodiment, a message which is displayed horizontally on a liquid crystal display panel is scrolled vertically. However, even if a message is displayed vertically, scroll display may be automatically performed on the message a plurality of times continuously in the horizontal direction. Accordingly, hitherto, the whole display content is switched from one page to another by pressing the button switch as if pages are sequentially turned. Unlike this conventional mode, according to the foregoing embodiment, the contents of display are easy to read, and a manual operation is not required, which would otherwise be troublesome and time-consuming.

The present invention may be used not only for compact-sized information communication apparatuses, but also for various types of information display apparatuses, and application and use of the present invention is not limited.

What is claimed is:

1. An information display apparatus comprising:
a display unit that displays information;
display control means for controlling a display operation of said display unit; and
an operating unit that designates a display operation of said display unit, said display control means causing display of a plurality of lines of characters of said information on said display unit in a font having a width that varies according to the type of character displayed, and said display control means controlling the display operation of said display unit so that a spacing between the characters is constant.

2. The information display apparatus according to claim 1, said display control means causing a new line of characters to be started whenever it would otherwise be required to break a word across two of said lines of characters.

3. The information display apparatus according to claim 1, said display control means causing said display unit to form a fixed display when an amount of information to be displayed is not greater than a number of lines displayable on said display unit in one frame, and said display control means causing said display unit to form a vertical scrolling display when an amount of information to be displayed exceeds a number of lines displayable on said display unit in one frame.

4. The information display apparatus according to claim 3, said display control means causing the scrolling display to be automatically scrolled a plurality of times continuously by said display unit.

5. The information display apparatus according to claim 3, said display control means changing a scroll speed for forming the scrolling display in accordance with an operation performed on said operating unit.

6. The information display apparatus according to claim 5, said display control means changing the scroll speed in accordance with an operation externally performed on said operating unit, the operation providing an instruction to change a predetermined scroll speed determined at the start of the scrolling display.

7. The information display apparatus according to claim 5, said display control means presetting the scroll speed determined at the start of the scrolling display by operation of a switch button on said operating unit.

8. The information display apparatus according to claim 7, said display control means causing said display unit to form a demonstration display at a currently set scroll speed, the scroll speed being determined at the start of the scrolling display by said operating unit.

9. An information display apparatus comprising:
a display unit that displays information;
display control means for controlling a display operation of said display unit; and
an operating unit that designates a display operation of said display unit, said display control means causing said display unit to form a fixed display when an amount of information to be displayed on said display unit is not greater than an amount displayable in one frame, and said display control means causing said display unit to automatically form a scrolling display a plurality of times continuously when an amount of information to be displayed exceeds an amount displayable on said display unit in one frame.

10. The information display apparatus according to claim 9, said display control means causing said display unit to display information formed of a group of characters vertically or horizontally over a plurality of lines.

11. The information display apparatus according to claim 9, said display control means changing a scroll speed for forming the scrolling display in accordance with an operation performed on said operating unit.

12. The information display apparatus according to claim 9, said display control means changing the scroll speed in accordance with an operation externally performed on said operating unit, the operation providing an instruction to change a predetermined scroll speed determined at the start of the scrolling display.

13. The information display apparatus according to claim 9, said display control means presetting the scroll speed determined at the start of the scrolling display by operation of a switch button on said operating unit.

14. The information display apparatus according to claim 13, said display control means causing said display unit to form a demonstration display at a currently set scroll speed, the scroll speed being determined at the start of the scrolling display by said operating unit.

15. The information display apparatus according to claim 1, further comprising a communication circuit that receives information, the information received via said communication circuit being displayed on said display unit in response to said display control means.

16. The information display apparatus according to claim 9, further comprising a communication circuit that receives information, the information received via said communication circuit being displayed on said display unit in response to said display control means.

17. The information display apparatus according to claim 15, further comprising informing means for informing the display control means whether the information received via said communication circuit exceeds a number of lines displayable in one frame of said display unit.

18. The information display apparatus according to claim 16, further comprising informing means for informing the display control means whether the information received via said communication circuit exceeds a number of lines displayable in one frame of said display unit.

19. The information display apparatus according to claim 15, further comprising an antenna unit for receiving a signal via said communication circuit.

20. The information display apparatus according to claim 16, further comprising an antenna unit for receiving a signal via said communication circuit.

21. The information display apparatus according to claim 19, said communication circuit receiving an individually selective calling signal or a message via said antenna unit.

22. The information display apparatus according to claim 20, said communication circuit receiving an individually selective calling signal or a message via said antenna unit.
